(19) United States
(12) Patent Application Publication
(10) Pub. No.: US 2025/0373099 A1
(43) Pub. Date: Dec. 4, 2025

(54) SPINDLE MOTOR AND HARD DISK DRIVE DEVICE

(71) Applicant: MINEBEA MITSUMI Inc., Kitasaku-gun (JP)

(72) Inventors: Akihiko SUZUKI, Kitasaku-gun (JP); Makoto CHONAN, Kitasaku-gun, Nagano (JP)

(21) Appl. No.: 19/064,867

(22) Filed: Feb. 27, 2025

(30) Foreign Application Priority Data
May 29, 2024 (JP) 2024-087139

(51) Int. Cl. H02K 1/28; G11B 5/00; G11B 19/20; H02K 1/04; H02K 1/2788; H02K 15/121; H02K 21/22

(52) U.S. Cl. CPC H02K 1/28; G11B 19/2009; H02K 1/04; H02K 1/2788; H02K 15/121; H02K 21/22; G11B 2005/0021

(57) ABSTRACT

A spindle motor included in a hard disk drive device using a heat assisted magnetic recording method as a magnetic recording method includes a plurality of components made of metal, a rotor magnet includes a main body part and a coating film covering a surface of the main body part, and at least one of a first pore exposed to the surface and a second pore exposed to a surface of the coating film is filled with a resin material.

### CROSS-REFERENCE TO RELATED APPLICATIONS

This application claims the benefit of priority to Japanese Patent Application Number 2024-087139 filed on May 29, 2024. The entire contents of the above-identified application are hereby incorporated by reference.

### TECHNICAL FIELD

The disclosure relates to a spindle motor and a hard disk drive device.

### BACKGROUND

Japanese Patent Application Laid-Open No. 2014-10882 discloses a hard disk drive device employing a heat assisted magnetic recording (HAMR) method as a recording method. In addition, Smear and Decomposition Mechanism of Magnetic Disk PFPE Lubricant film by Laser Heating in Air and Helium Conditions (Tribology online Vol. 15, No. 3 (2020) 186 to 193.) discloses that the presence of oxygen is useful for decomposition of organic impurities attached on a recording disk and causing read/write errors, in such a hard disk drive device.

### SUMMARY

Incidentally, many components constituting the hard disk drive device are made of metal. Therefore, the components may react with oxygen in a sealed interior space of the hard disk drive device, and the oxygen concentration in the interior space may decrease. As a result, the decomposition of the organic impurities described above may be suppressed.

An object of the disclosure is to provide a structure for making it difficult for components to be oxidized in an interior space of a hard disk drive device.

In order to achieve the above object, there is provided a spindle motor provided in a hard disk drive device using a heat assisted magnetic recording method as a magnetic recording method, the spindle motor including a plurality of components made of metal, wherein at least one of the components includes a main body member and a coating film covering a surface of the main body member, and at least one of a first pore exposed to the surface or a second pore exposed to a surface of the coating film is filled with a resin material.

According to the disclosure, it is possible to provide a structure for making it difficult for components to be oxidized in an interior space of a hard disk drive device.

### BRIEF DESCRIPTION OF DRAWINGS

FIG. 1 is a perspective view of a hard disk drive device 1.

FIG. 2 is a cross-sectional view of a spindle motor 3.

FIG. 3 is a cross-sectional view of a rotor magnet 90 taken along a plane including a radial direction and a circumferential direction.

FIG. 4 is an enlarged view of a part IV in FIG. 3.

FIG. 5 is a flowchart showing an impregnation treatment.

FIG. 6 is an enlarged cross-sectional view of the rotor magnet 90 in a modification.

FIG. 7 is an enlarged view of a part VII in FIG. 6.

FIG. 8 is a view illustrating a spindle motor 103 of a type having a shaft fixed to the spindle motor.

FIG. 9 is a view illustrating a spindle motor 203 of a type having a shaft fixed to the spindle motor.

### DESCRIPTION OF EMBODIMENTS

Hereinafter, an embodiment of the disclosure will be described with reference to the drawings. However, while the embodiment described below is subject to various technically preferable limitations for carrying out the disclosure, the scope of the disclosure is not limited to the following embodiment and illustrated examples.

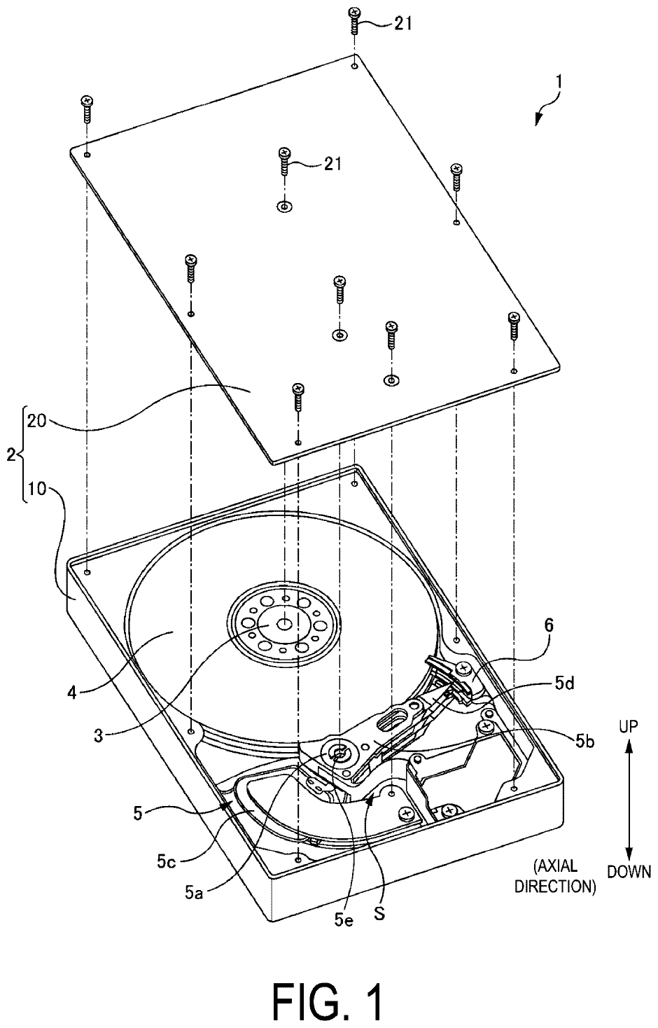

FIG. 1 is a perspective view illustrating a configuration of a hard disk drive device 1.

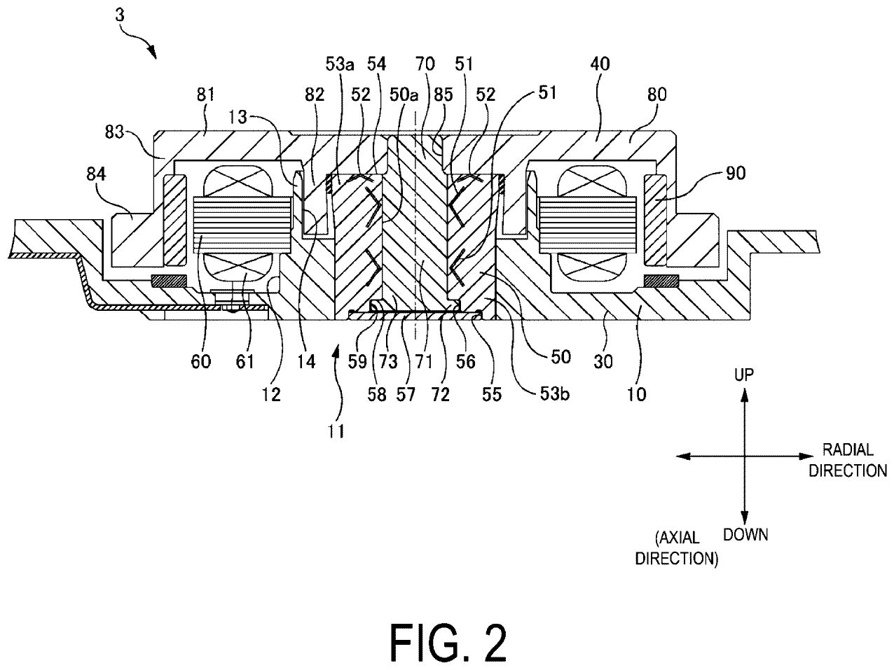

FIG. 2 is a cross-sectional view of a spindle motor 3.

Here, as illustrated in FIG. 2 and the like, a direction parallel to a center axis of a shaft 70 described later is defined as an axial direction, a direction around the center axis of the shaft 70 is defined as a circumferential direction, and a direction perpendicular to the axial direction is defined as a radial direction. For the sake of description, the axial direction is defined as an up-down direction, where a cover 20 side is up and a base plate 10 side is down.

### Hard Disk Drive Device

The hard disk drive device 1 is a hard disk drive device employing a heat assisted magnetic recording method. The hard disk drive device 1 includes a housing 2, a spindle motor 3, a recording disk 4, and a data reading/writing device 5.

The housing 2 is a box-shaped case accommodating the spindle motor 3 and the like. The housing 2 includes a base plate 10 and a cover 20. The base plate 10 has a bottomed box shape with one surface open. The cover 20 is fastened to the base plate 10 using a screw 21 being a fastening body. A seal means (not illustrated) such as a gasket or an adhesive is provided between the base plate 10 and the cover 20. Thereby, the base plate 10 and the cover 20 form the housing 2 having an interior space S.

The interior space S of the housing 2 is filled with air and other gases. The interior space S accommodates the spindle motor 3, the recording disk 4, and the data reading/writing device 5.

The spindle motor 3 rotatably supports a plurality of the recording disks 4. Note that a detailed structure of the spindle motor 3 will be described later.

The plurality of recording disks 4 are provided and supported by the spindle motor 3 such that respective disk surfaces face one another. Gaps are formed between the respective recording disks 4. Note that for the sake of description, in a state of being supported by the spindle motor 3, an upper surface of the recording disk 4 is referred to as a front surface, and a lower surface is referred to as a back surface.

The data reading/writing device 5 records data into the recording disk 4 or reads data from the recording disk 4. The data reading/writing device 5 includes a pivot post 5a, a swing arm 5b, a voice coil motor 5c, and a magnetic head 5d.

The pivot post 5a swingably supports a plurality of the swing arms 5b. The pivot post 5a is a member extending in the up-down direction. The pivot post 5a has a female screw part Se on an upper surface. In the present embodiment, the pivot post 5a is integrated with the base plate 10. Note that the pivot post 5a may be configured as a component separate from the base plate 10 and attached to the base plate 10.

The swing arm 5b is swingably supported by the pivot post 5a. The swing arm 5b is disposed in a gap between the respective recording disks 4 and on the uppermost surface and lowermost surface of the recording disk 4. The number of swing arms 5b is larger by one than the number of recording disks 4.

The voice coil motor 5c swings the swing arm 5b around the pivot post 5a as a rotation center. In addition, the voice coil motor 5c swings the swing arm 5b in parallel with the front surface of the recording disk 4.

The magnetic head 5d magnetizes the recording disk 4 and reads magnetism from the recording disk 4. The magnetic head 5d is provided at a tip end of the swing arm 5b. One magnetic head 5d is provided for each of the front surface and the back surface of each of the plurality of recording disks 4.

The magnetic head 5d is disposed in a ramp mechanism 6 provided at a position away from the recording disk 4. The ramp mechanism 6 is a portion forming a retraction position of the magnetic head 5d. When the voice coil motor 5c is activated and the swing arm 5b swings, the magnetic head 5d moves from the ramp mechanism 6 to above the front surface or below the back surface of the recording disk 4, or moves from above the front surface or below the back surface of the recording disk 4 to the ramp mechanism 6.

When the spindle motor 3 rotates, the recording disk 4 also rotates. When the swing arm 5b swings in this state, the magnetic head 5d moves from the ramp mechanism 6 to above the front surface or below the back surface of the rotating recording disk 4. Then, the magnetic head 5d magnetizes the recording disk 4 and records data onto the recording disk 4. In addition, the magnetic head 5d reads magnetism from the recording disk 4 and reads data recorded on the recording disk 4. On the other hand, when the magnetic head 5d does not magnetize the recording disk 4 or the magnetic head 5d does not read magnetism from the recording disk 4, the swing arm 5b swings, and the magnetic head 5d moves from above the front surface or below the back surface of the rotating recording disk 4 to the ramp mechanism 6.

### Spindle Motor

Next, a detailed configuration of the spindle motor 3 will be described. The spindle motor 3 includes a stationary part 30 and a rotating part 40 rotating with respect to the stationary part 30 via a bearing mechanism.

### Stationary Part

The stationary part 30 includes a base plate 10, a bearing sleeve 50, and a stator core 60.

The base plate 10 is a member made of metal. The base plate 10 is formed with a through hole 11, a circumferential groove part 12, a circumferential wall part 13, and a plate recess part 14.

The through hole 11 is a hole for fixing a bearing sleeve 50. The through hole 11 is provided to penetrate the base plate 10 in the axial direction. The through hole 11 has a tube shape, and the inner diameter of the tube shape is approximately equal to or larger than the outer diameter of the bearing sleeve 50.

The circumferential groove part 12 is formed at an outer side of the through hole 11 in the radial direction. The circumferential groove part 12 is an annular groove provided to be coaxial with a center axis of the through hole 11 when viewed in the axial direction.

The circumferential wall part 13 is formed at an outer side of the through hole 11 and at an inner side of the circumferential groove part 12 in the radial direction. The circumferential wall part 13 is an annular wall provided to be coaxial with the center axis of the through hole 11 when viewed in the axial direction, and protrudes upward in the axial direction.

The plate recess part 14 is formed at an inner side of the circumferential wall part 13 in the radial direction. The plate recess part 14 is a columnar space provided to be coaxial with the center axis of the through hole 11 when viewed in the axial direction and opens upward. The diameter of the plate recess part 14 is larger than the outer diameter of the through hole 11. The plate recess part 14 is connected to an upper side of the through hole 11 in the axial direction.

The bearing sleeve 50 rotatably supports a shaft 70. The bearing sleeve 50 is a cylindrical member made of iron, such as stainless steel. The bearing sleeve 50 is inserted into the through hole 11 (see FIG. 2). The bearing sleeve 50 is fixed to the through hole 11 with an adhesive applied to one surface or both surfaces of an outer peripheral surface of the bearing sleeve 50 and an inner peripheral surface of the through hole 11. The bearing sleeve 50 is provided with radial dynamic pressure generating grooves 51 and a thrust dynamic pressure generating groove 52.

The radial dynamic pressure generating grooves 51 are provided on an inner peripheral surface 50a of the bearing sleeve 50. In the present embodiment, the radial dynamic pressure generating grooves 51 are formed on the inner peripheral surface 50a in a continuous row in the circumferential direction, and are formed in two rows with an interval in the axial direction.

The thrust dynamic pressure generating groove 52 is provided at an end surface 54 of a sleeve end part 53a positioned at the upper side of the bearing sleeve 50 in the axial direction. The thrust dynamic pressure generating groove 52 is provided in an annular shape so as to be coaxial with the center axis of the bearing sleeve 50 when viewed in the axial direction.

A large-diameter recess part 55 and a small-diameter recess part 56 are formed continuously in the axial direction at a sleeve end part 53b of the bearing sleeve 50 at the lower side in the axial direction. A counter plate 57 is attached to the large-diameter recess part 55.

The large-diameter recess part 55 is formed at the sleeve end part 53b. The large-diameter recess part 55 is a columnar space provided to be coaxial with the center axis of the through hole 11 when viewed in the axial direction. The large-diameter recess part 55 opens downward.

The small-diameter recess part 56 is formed at an upper side of the large-diameter recess part 55 in the sleeve end part 53b. The small-diameter recess part 56 is a columnar space provided to be coaxial with the center axis of the through hole 11 when viewed in the axial direction. The small-diameter recess part 56 is connected to the large-diameter recess part 55 in the axial direction. The diameter of the small-diameter recess part 56 is smaller than the diameter of the large-diameter recess part 55. Since the small-diameter recess part 56 is formed at the sleeve end part 53b, the bearing sleeve 50 is formed with an annular surface 58 having an annular shape when viewed in the axial direction and an inner peripheral side surface 59 in the circumferential direction.

The counter plate 57 is a lid having a disk shape and inserted into the large-diameter recess part 55 from below the sleeve end part 53b. The counter plate 57 closes the large-diameter recess part 55 and the small-diameter recess part 56. The counter plate 57 is a member made of iron, such as stainless steel. The outer diameter of the counter plate 57 is substantially equal to the inner diameter of the large-diameter recess part 55. The thickness of the counter plate 57 in the axial direction is substantially equal to the depth of the large-diameter recess part 55.

When the counter plate 57 is inserted into the large-diameter recess part 55, an outer edge part of the counter plate 57 and an inner edge part of the large-diameter recess part 55 are bonded by laser welding. In this way, the counter plate 57 is fixed to the bearing sleeve 50 without a gap and closes the large-diameter recess part 55 and the small-diameter recess part 56.

The stator core 60 is a member formed by stacking, in the axial direction, a plurality of electromagnetic steel sheets having an annular shape when viewed in the axial direction. The stator core 60 is disposed and fixed inside the circumferential groove part 12 by a method such as bonding. The stator core 60 has a plurality of pole teeth (protruding poles) extending radially outward and arranged along the circumferential direction. A coil 61 is wound around the pole teeth. The stator core 60 generates a magnetic flux when a current flows through the coil 61.

### Rotating Part

The rotating part 40 includes a shaft 70, a rotor hub 80, and a rotor magnet 90.

The shaft 70 is a member serving as a rotation axis of the spindle motor 3. The shaft 70 is rotatably supported inside the bearing sleeve 50. The shaft 70 includes a shaft part 71 having a pillar shape and a flange part 72. In the shaft 70, the shaft part 71 and the flange part 72 are integrated with each other.

The shaft part 71 is a columnar shaft member. In the shaft part 71, a shaft end part 73 at the lower side is integrally provided with the flange part 72. The shaft part 71 is disposed inside the bearing sleeve 50 such that the shaft end part 73 provided with the flange part 72 is positioned at the lower side. That is, an outer peripheral surface of the shaft part 71 is surrounded by the inner peripheral surface 50a of the bearing sleeve 50. Then, the outer peripheral surface of the shaft part 71 and the inner peripheral surface 50a of the bearing sleeve 50 are opposed to each other with a minute gap. Note that the radial dynamic pressure generating grooves 51 may be formed on the outer peripheral surface of the shaft part 71 instead of the inner peripheral surface 50a of the bearing sleeve 50.

The flange part 72 is a ring-shaped flange member expanding in the radial direction when viewed in the axial direction. The flange part 72 is disposed at the small-diameter recess part 56 in a state of supporting the shaft 70 by the bearing sleeve 50. The outer diameter of the flange part 72 is smaller than the inner diameter of the small-diameter recess part 56. An upper surface of the flange part 72 is opposed to an annular surface 58 formed by the small-diameter recess part 56 at the bearing sleeve 50 with a minute gap. A lower surface of the flange part 72 is opposed to an upper surface of the counter plate 57 with a minute gap. A side surface of the flange part 72 is opposed to the inner peripheral side surface 59 with a minute gap. Since the flange part 72 is disposed between the annular surface 58 and the counter plate 57, the flange part 72 and the shaft 70 are prevented from moving in the axial direction.

A lubricating oil is filled between the shaft 70 and the bearing sleeve 50. Specifically, the lubricating oil is filled between the outer peripheral surface of the shaft part 71 and the inner peripheral surface 50a of the bearing sleeve 50, between the upper surface of the flange part 72 and the annular surface 58, between the lower surface of the flange part 72 and the upper surface of the counter plate 57, and between the side surface of the flange part 72 and the inner peripheral side surface 59.

The rotor hub 80 is a member configured to rotate together with the shaft 70. The rotor hub 80 is attached to an upper end of the shaft 70 and is connected to the shaft 70. The rotor hub 80 includes a disk part 81, a first cylindrical part 82, a second cylindrical part 83, and an outer edge part 84.

The disk part 81 is a disk-shaped member being coaxial with the center axis of the shaft 70 when viewed in the axial direction. The disk part 81 includes a rotor hub through hole 85. The rotor hub through hole 85 is provided at the center of the disk part 81 when viewed in the axial direction. The disk part 81 is fixed to the shaft 70. Specifically, by inserting and fixing the upper end of the shaft 70 into the rotor hub through hole 85 by a method such as press-fitting or bonding, the disk part 81 is fixed to the shaft 70. In a state of supporting the shaft 70 by the bearing sleeve 50, the disk part 81 is opposed to the end surface 54 of the bearing sleeve 50 with a minute gap.

The first cylindrical part 82 is a cylindrical member having a thickness in the radial direction. The first cylindrical part 82 is provided to be coaxial with the center axis of the rotor hub through hole 85 when viewed in the axial direction, and protrudes downward in the axial direction from a lower surface of the disk part 81. The inner diameter of the first cylindrical part 82 is larger than the outer diameter of the bearing sleeve 50. An inner peripheral surface of the first cylindrical part 82 is opposed to the outer peripheral surface of the bearing sleeve 50 with a gap. The outer diameter of the first cylindrical part 82 is smaller than the inner diameter of the circumferential wall part 13. An outer peripheral surface of the first cylindrical part 82 is opposed to an inner peripheral surface of the circumferential wall part 13 with a gap.

The second cylindrical part 83 is a cylindrical member having a thickness in the radial direction. The second cylindrical part 83 is provided to be coaxial with the center axis of the rotor hub through hole 85 when viewed in the axial direction, and protrudes downward in the axial direction from the lower surface of the disk part 81. The second cylindrical part 83 is provided at an outer edge of the disk part 81.

The outer edge part 84 is an annular member. The outer edge part 84 is provided at a lower end of the second cylindrical part 83. The outer edge part 84 protrudes outward in the radial direction from the second cylindrical part 83 and is formed in a flange shape. The plurality of recording disks 4 are installed above the outer edge part 84 and at an outer side in the radial direction of the second cylindrical part 83 (see FIG. 1).

A lubricating oil is filled between the rotor hub 80 and the bearing sleeve 50. Specifically, the lubricating oil is filled between a lower surface of the disk part 81 at an inner side in the axial direction with respect to the first cylindrical part 82 and the end surface 54 of the sleeve end part 53a at an upper side in the axial direction of the bearing sleeve 50.

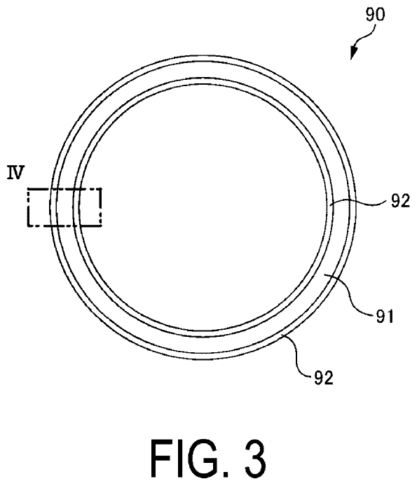

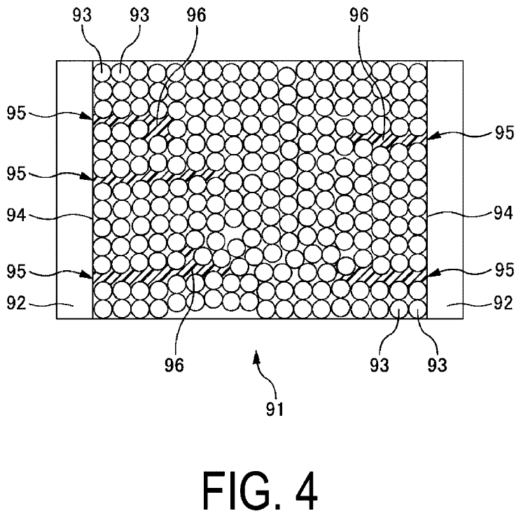

The rotor magnet 90 is an annular member having a magnetic pole structure magnetized in a state of the polarities of N and S being alternately reversed along the circumferential direction when viewed in the axial direction. In the present embodiment, the rotor magnet 90 is attached to an inner peripheral surface of the second cylindrical part 83. As shown in FIGS. 3 and 4, the rotor magnet 90 includes a main body part 91 and a coating film 92.

The main body part 91 is a member covered with the coating film 92. The main body part 91 is a magnetized magnet. The main body part 91 of the present embodiment is a bond magnet formed by mixing a powder body 93 of magnet powder and a binder resin (not illustrated) and molding the mixture. Here, the magnet powder is, for example, rare earth magnet powder, ferrite magnet powder, or the like. In addition, the binder resin is a thermoplastic resin, such as a polyamide resin, or a thermosetting resin, such as an epoxy resin. A surface 94 of the main body part 91 is formed with a plurality of first pores 95.

The first pores 95 are holes formed in the surface 94. In the present embodiment, the first pores 95 are holes formed between a plurality of the powder bodies 93. The first pores 95 are filled with a resin material 96 and blocked.

The resin material 96 is a member blocking the first pores 95. The resin material 96 is filled in the first pores 95 by impregnating the main body part 91. In the present embodiment, the resin material 96 is preferably an acrylic resin. The resin material 96 may be an epoxy resin or the like used for an impregnation treatment. The impregnation treatment with the resin material 96 will be described later.

The coating film 92 is a film covering the surface 94 of the main body part 91. The coating film 92 is an electrodeposition coating film where an epoxy resin is attached to the surface 94 by cationic electrodeposition coating. In addition, the coating film 92 is overbaked. The electrodeposition coating and overbaking will be described later.

Note that the coating film 92 may be an electrodeposition coating film other than the epoxy resin. In addition, the coating film 92 may be a metal thin film formed on the surface 94 by a plating process such as electroless nickel plating.

### Operation of Spindle Motor

When the coil 61 is energized, magnetic attractive forces and magnetic repulsive forces generated between the magnetic poles of the rotor magnet 90 and the pole teeth of the stator core 60 are switched. As a result, the rotating part 40 rotates with respect to the stationary part 30 about the shaft 70 as a rotation axis.

The shaft 70 rotates with respect to the bearing sleeve 50. Here, the lubricating oil is pressurized by the radial dynamic pressure generating grooves 51, and thus a dynamic pressure is generated in the lubricant oil. By the generated dynamic pressure, the shaft 70 is supported in a non-contact state in the radial direction with respect to the bearing sleeve 50.

The shaft 70 rotates, and thus the rotor hub 80 rotates with respect to the bearing sleeve 50. At this time, the lubricating oil is pressurized by the thrust dynamic pressure generating groove 52, and thus a dynamic pressure is generated in the lubricating oil. By the generated dynamic pressure, the rotor hub 80 is supported in a non-contact state in the axial direction with respect to the bearing sleeve 50.

### Manufacturing Process of Rotor Magnet

In the rotor magnet 90 of the present embodiment, the main body part 91 being a bond magnet is subjected to an impregnation treatment, and then the coating film 92 being an electrodeposition coating film of an epoxy resin is formed on the surface 94 by cationic electrodeposition coating.

### Impregnation Treatment Process

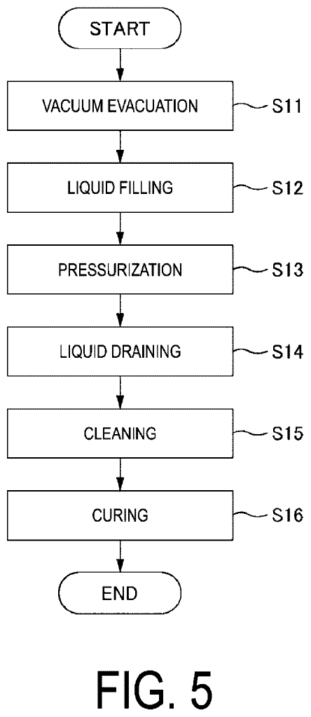

Next, the impregnation treatment performed on the main body part 91 will be described. In the present embodiment, a vacuum pressure impregnation treatment is employed. FIG. 5 is a flowchart showing each process of the vacuum pressure impregnation treatment. The vacuum pressure impregnation treatment consists of six steps from S11 to S16. Note that the impregnation treatment is not limited to the vacuum pressure impregnation treatment, and any impregnation treatment method such as vacuum impregnation treatment without pressurizing, and immersion and impregnation treatment of immersing the main body part 91 in an impregnating material can be employed.

### S11

S11 is a vacuum evacuation step. An operator disposes the main body part 91 inside a chamber capable of being depressurized and pressurized, and closes a lid of the chamber. Next, the operator depressurizes the inside of the chamber to a vacuum state (1 kPa or less).

### S12

S12 is a liquid filling step. The operator causes the resin material 96 to be sucked into the chamber in a vacuum state. Here, an acrylic resin is used as the resin material 96. Note that the resin material 96 to be used may be a resin material generally used in the impregnation treatment, such as an epoxy resin. In addition, the viscosity of the resin material 96 in a liquid (uncured) state is preferably equal to or greater than 2 mPa·s and equal to or less than 50 mPa·s.

### S13

S13 is a pressurization step. The operator pressurizes the inside of the chamber having the resin material 96 sucked in the chamber. Thereby, the resin material 96 is filled in the first pores 95 of the main body part 91. After a lapse of time until a sufficient amount of the resin material 96 is filled in the first pores 95, the operator depressurizes the inside of the chamber and removes the resin material 96 from the inside of the chamber. Next, the operator confirms that the pressure inside the chamber is in the same state as the outside air pressure, opens the lid of the chamber, and takes out the main body part 91 from the inside of the chamber.

### S14

S14 is a liquid draining step. The operator disposes the main body part 91 taken out from the inside of the chamber in a centrifugal separator. Then, the operator operates the centrifugal separator to remove the excess resin material 96 adhering to the surface of the main body part 91. Next, the operator stops the centrifugal separator and takes out the main body part 91 from the centrifugal separator.

### S15

S15 is a cleaning step. The operator disposes the main body part 91 taken out from the centrifugal separator in a cleaning machine. Next, the operator operates the cleaning machine to repeatedly clean the main body part 91 with water and hot water, thereby further removing the excess resin material 96 adhering to the surface of the main body part 91. Then, the operator stops the cleaning machine and takes out the main body part 91 from the cleaning machine. Thereafter, the operator disposes the main body part 91 in the centrifugal separator. Then, the operator operates the centrifugal separator to remove water adhering to the surface of the main body part 91. Next, the operator stops the centrifugal separator and takes out the main body part 91 from the centrifugal separator.

### S16

S16 is a curing step. The operator immerses the main body part 91 in hot water and cures the resin material 96 filled in the first pores 95. After the resin material 96 is cured, the operator takes out the main body part 91 from the hot water and dries the main body part 91. Note that as a method of curing the resin material 96, in addition to the method of immersing the main body part in hot water, there is also a method of inserting, heating, and curing the main body part in an oven or the like.

### Electrodeposition Coating Process

Next, the electrodeposition coating performed on the main body part 91 will be described. The electrodeposition coating is treatment of immersing a coating target member in a tank filled with a coating material, causing the coating material to adhere to a surface of the coating target member by energizing the coating target member, and then drying and thermally curing the coating material. When performing the electrodeposition coating on the main body part 91, as the coating material, a coating film forming material containing a benzene ring-containing epoxy resin and a pigment containing an aluminum silicate component is preferably used. Note that a coating material containing an epoxy-polyamide-based resin may be used as the coating material.

Next, the electrodeposition coating process will be described. First, the main body part 91 is immersed in a tank filled with a coating material and is energized. When the main body part 91 is pulled up from the tank, the coating material adheres to the surface of the main body part 91.

Next, the main body part 91 with the coating material adhering to the surface is heated, and the coating material is heated and cured. Here, the main body part 91 with the coating material adhering to the surface is normally heated at a temperature of about 200° C. to 220° C. for about 10 minutes to 60 minutes, but in the present embodiment, is heated at a temperature of 280° C. for about 10 minutes to 60 minutes. The heating temperature is preferably equal to or more than 250° C. because the heating time can be shortened. As described above, when the coating material is heated and cured, setting the heating temperature to be high without changing the heating time or setting the heating time to be long without changing the heating temperature to promote thermal curing of the coating material more than usual is called overbaking. That is, the coating film 92 being an epoxy resin-containing electrodeposition coating film subjected to overbaking is formed on the surface of the main body part 91.

Here, overbaking will be described below. The overbaking is a process of baking a coating film-forming material by supplying energy larger than the energy required for setting crosslinks (bonds) existing between molecules constituting the coating film to a desired state (that is, a cured state). The overbaking may be caused by excessive heating time, excessive heating temperature, or both excessive heating time and excessive heating temperature.

Overbaking of a coating film containing resin or the like may result in more crosslinks being formed than crosslinks by predetermined baking. Then, the overbaking results in more crosslinks being formed, the number of positions capable of forming the crosslinks is reduced, and thus the overbaked coating film containing the resin or the like causes uptake of oxygen atoms contributing to crosslink formation to be suppressed. Additionally, the formation of crosslinks caused by the overbaking is considered to lead to an increase in the hardness of the overbaked coating film containing the resin or the like.

### Modifications

Note that the hard disk drive device 1 may be a combination of the following changes.

### (1) Modification 1

The rotor magnet 90 may be subjected to the impregnation treatment after the electrodeposition coating.

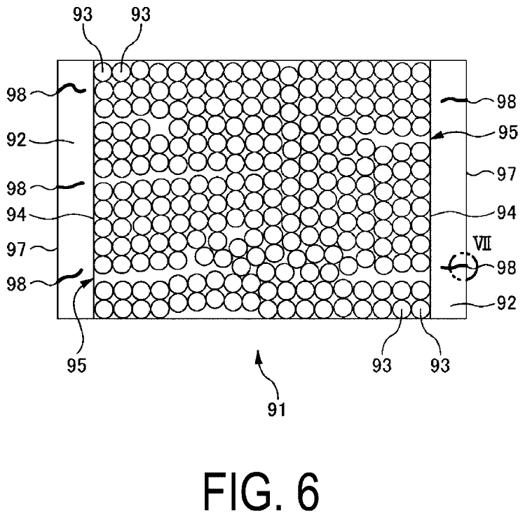

In the present modification, the main body part 91 of the rotor magnet 90 is a bond magnet as in the above-described embodiment. However, since the impregnation treatment is performed after the electrodeposition coating, as illustrated in FIG. 6, the first pores 95 are not filled with the resin material 96. On the other hand, a plurality of second pores 98 are formed in the surface 97 of the coating film 92.

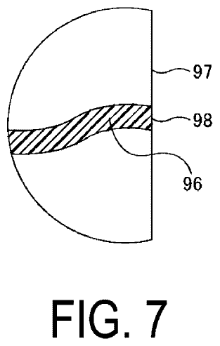

The second pore 98 is a hole formed in the surface 97. As illustrated in FIG. 7, the second pores 98 are filled with the resin material 96 and blocked. The resin material 96 is filled in the second pores 98 by a method similar to the impregnation treatment described above.

### (2) Modification 2

The rotor magnet 90 may be subjected to electrodeposition coating after the impregnation treatment, and may be further subjected to the impregnation treatment. That is, both the first pores 95 and the second pores 98 may be filled with the resin material 96.

### (3) Modification 3

Components other than the rotor magnet 90 constituting the spindle motor 3 may be subjected to the impregnation treatment and the coating formation treatment performed on the rotor magnet 90. Here, the components constituting the spindle motor 3 are components made of metal, such as a stator core, a rotor hub, a shaft, a sleeve, a pivot post, components of a voice coil motor, and a base plate.

### (4) Modification 4

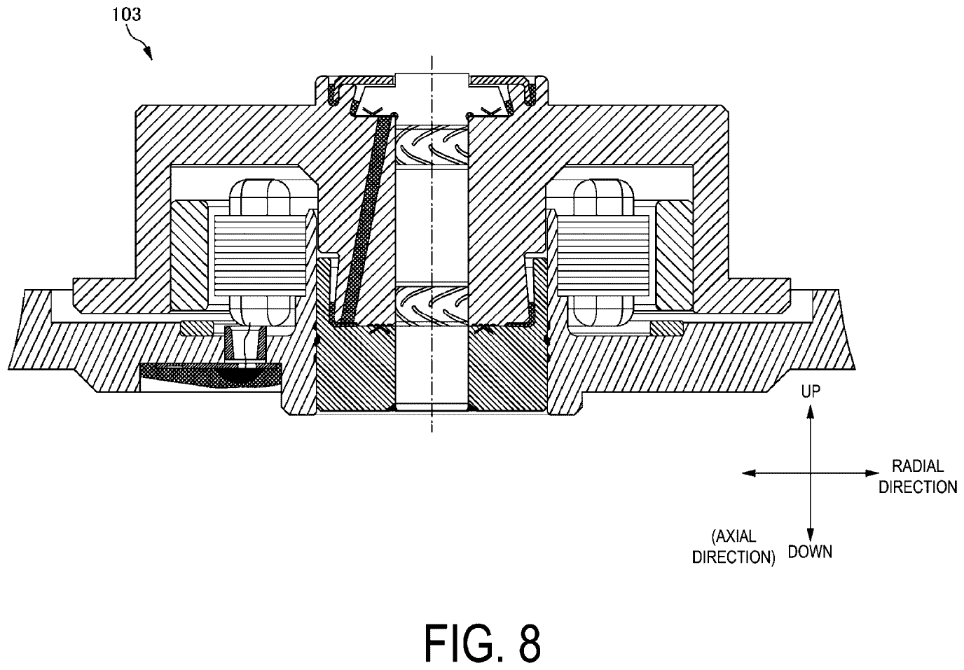

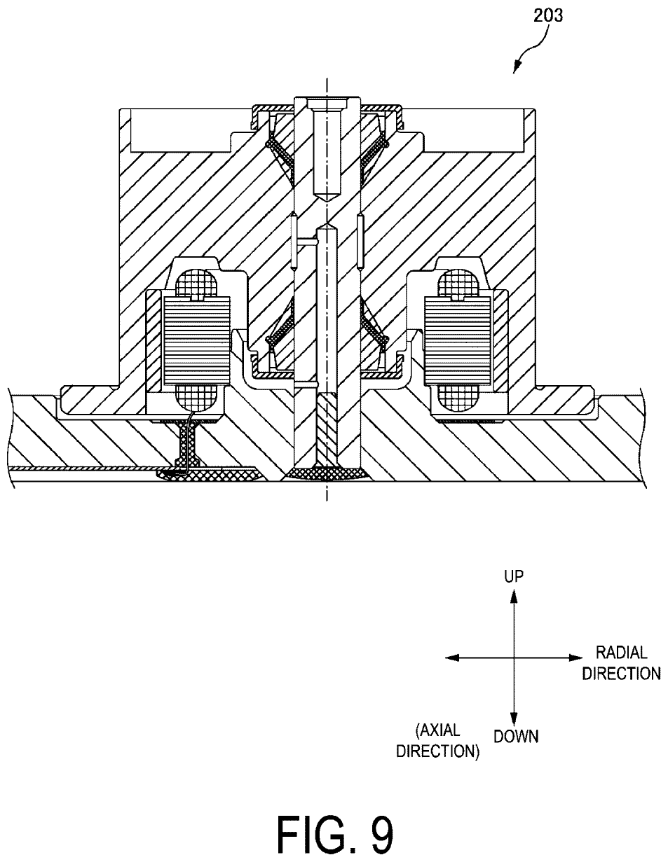

The spindle motor 3 may be a spindle motor 103 or 203 of a type having a shaft fixed to the spindle motor, as illustrated in FIGS. 8 and 9, in addition to a type rotating a shaft.

### Effects

(Aspect 1) In this embodiment, the spindle motor 3 provided in the hard disk drive device 1 using a heat assisted magnetic recording method as a magnetic recording method includes a plurality of components made of metal, the rotor magnet 90 includes the main body part 91 and the coating film 92 covering the surface 94 of the main body part 91, and at least one of the first pores 95 exposed to the surface 94 and the second pores 98 exposed to the surface 97 of the coating film 92 is filled with the resin material 96.

In the spindle motor 3 described above, since at least one of the first pores 95 of the main body part 91 of the rotor magnet 90 and the second pores 98 of the coating film 92 is filled with the resin material 96, the main body part 91 is less likely to come into contact with oxygen. Therefore, it is possible to provide a structure for making it difficult for components of the spindle motor 3 being a constituent element of the hard disk drive device 1 to be oxidized in the interior space of the hard disk drive device 1.

(Aspect 2) In Aspect 1, the resin material 96 is filled in the first pores 95.

In the rotor magnet 90 being a component of the spindle motor 3 described above, since the resin material 96 is filled in the first pores 95, oxygen is difficult to enter the first pores 95. Therefore, the spindle motor 3 is unlikely to be oxidized.

(Aspect 3) In Aspect 1, the resin material 96 is filled in the second pores 98.

In the rotor magnet 90 being a component of the spindle motor 3 described above, since the resin material 96 is filled in the second pores 98, oxygen is suppressed from entering the second pores 98. In other words, oxygen is unlikely to come into contact with the main body part 91. Therefore, the spindle motor 3 is unlikely to be oxidized.

(Aspect 4) In any one of Aspects 1 to 3, the resin material 96 is an acrylic resin.

In the rotor magnet 90, the rotor magnet 90 being a component of the spindle motor 3 described above, the resin material 96 is an acrylic resin. Since acrylic resin is a general resin material, it is inexpensive. Therefore, the additional cost required for filling the resin material 96 into the first pores 95 and the second pores 98 by the impregnation treatment is small.

(Aspect 5) In any one of Aspects 1 to 4, the viscosity of the resin material 96 before being cured is, for example, equal to or greater than 2 mPa·s and equal to or less than 50 mPa·s, or equal to or greater than 3 mPa·s and equal to or less than 20 mPa·s.

In the spindle motor 3 described above, the viscosity of the resin material 96 constituting the rotor magnet 90 before being cured is as low as equal to or greater than 2 mPa·s and equal to or less than 50 mPa·s. Therefore, the resin material 96 is likely to enter the first pores 95 and the second pores 98.

(Aspect 6) In any one of Aspects 1 to 5, the coating film 92 is an overbaked electrodeposition coating film.

In the spindle motor 3 described above, the coating film 92 of the rotor magnet 90 is overbaked. Since the overbaked coating film 92 has a characteristic of being hardly oxidized, the rotor magnet 90 is unlikely to be oxidized.

(Aspect 7) The hard disk drive device 1 using a heat assisted magnetic recording method as a magnetic recording method includes the spindle motor 3 according to any one of Aspects 1 to 6.

According to the hard disk drive device 1 described above, the spindle motor 3 having components being unlikely to be oxidized is provided. Therefore, oxygen is unlikely to be consumed in the interior space S of the hard disk drive device 1.

While preferred embodiments of the disclosure have been described above, it is to be understood that variations and modifications will be apparent to those skilled in the art without departing from the scope and spirit of the disclosure. The scope of the disclosure, therefore, is to be determined solely by the following claims.

1. A spindle motor provided in a hard disk drive device using a heat assisted magnetic recording method as a magnetic recording method, the spindle motor comprising:
a plurality of components made of metal, wherein
at least one of the components comprises a main body member and a coating film covering a surface of the main body member, and
at least one of a first pore exposed to the surface or a second pore exposed to a surface of the coating film is filled with a resin material.

2. The spindle motor according to claim 1, wherein the resin material is filled in the first pore.

3. The spindle motor according to claim 1, wherein the resin material is filled in the second pore.

4. The spindle motor according to claim 1, wherein the resin material is an acrylic resin.

5. The spindle motor according to claim 1, wherein a viscosity of the resin material before being cured is equal to or greater than 2 mPa·s and equal to or less than 50 mPa·s.

6. The spindle motor according to claim 1, wherein the coating film is an overbaked electrodeposition coating film.

7. The spindle motor according to claim 1, wherein the main body member is any one of a rotor magnet, a stator core, a rotor hub, a shaft, a sleeve, a pivot post, and a voice coil motor.

8. The spindle motor according to claim 7, wherein the main body member is a rotor magnet.

9. The spindle motor according to claim 8, wherein the rotor magnet is a bond magnet.

10. A hard disk drive device using a heat assisted magnetic recording method as a magnetic recording method, the hard disk drive device comprising:
the spindle motor according to claim 1.
